(19) United States
(12) Patent Application Publication
(10) Pub. No.: US 2018/0068269 A1
(43) Pub. Date: Mar. 8, 2018

(54) METHODS OF OPTIMIZING CARRIER LOADS TRANSPORTED ACROSS A TRANSPORTATION NETWORK BY TRANSPORT CARRIERS

(71) Applicant: UST Global (Singapore) Pte. Ltd., Singapore (SG)

(72) Inventors: Anoj Sivarama Pillai, Aliso Viejo, CA (US); Randall Menna, Aliso Viejo, CA (US); Saju Jacob, Aliso Viejo, CA (US); Subhodip Bandyopadhyay, Aliso Viejo, CA (US); Sundaram Subbiah, Aliso Viejo, CA (US); Vibi Varughese, Aliso Viejo, CA (US); Zsolt Benedek, Aliso Viejo, CA (US)

(21) Appl. No.: 15/697,119

(22) Filed: Sep. 6, 2017

Related U.S. Application Data
(60) Provisional application No. 62/383,998, filed on Sep. 6, 2016.

(51) Int. Cl. G06Q 10/08

(52) U.S. Cl. CPC G06Q 10/08345

(57) ABSTRACT

A carrier load optimization for shippers whereby a set of preferred carriers is placed under contract or committed to certain standard rate for any route or point to point delivery lane, and a supplemental or open set of carriers are authorized for deliveries in a particular lane, based on ad-hoc spot pricing and spot price negotiation. Carrier tender offers are submitted in two processing stages; first simultaneously under a standard or contract rate, and secondly if no shipper responses are accepted or a time deadline is reached, then subsequent tenders are released and updated in accordance with the dynamic spot pricing optimization logic of the preferred solution. Machine learning is employed to maintain and understand rate history and current delivery trends including carrier performance.

### CROSS-REFERENCE TO RELATED APPLICATION

This application claims the benefit of and priority to U.S. Provisional Application No. 62/383,998, filed on Sep. 6, 2016, which is hereby incorporated by reference herein in its entirety.

### FIELD OF THE INVENTION

Aspects of the present disclosure relate to machine learning or artificial intelligence, and, more particularly, to a neural network that optimizes the efficient transportation of tangible loads using physical carriers across a real-world transportation network.

### BACKGROUND OF THE INVENTION

The field of logistics for most industries requires the shipment of tangible goods between manufacturers or supply centers to regional or local distributions centers, and then to commercial store locations or direct to consumers.

Large enterprises engaged in intra-/inter-state transportation (shipping) of tangible goods via trucks face a growing logistical challenge of effectively and economically managing their own and their shipping partners' trucking assets. Solving the problems associated with determining which trucks are available and when, and matching them to loads scheduled for transport becomes more difficult as the shipper's business grows. Current solutions and processes sometimes require manual linking of trucks with loads which results in loss of efficiency, time, and monies. Failed or late deliveries can also result in damage to customer and partner relationships.

The inability of current systems and processes to effectively manage thousands of trucks and thousands of loads results in unscheduled truck downtime, late shipments, and failure to transport goods that are ready and expected to ship.

While the present invention applies directly to the management of motor vehicle loads from manufacturers to certain distribution centers using any one of a set of multiple available carriers, the novelty of the preferred solution is applicable to any logistics routing, including international, air, sea, or land deliveries where arms-length contracting and spot pricing is required to commit carriers to specific shipping requests for point to point delivery of designated loads by required deadlines.

### Pre-Existing Practices

Conventionally best practices involve multiple systems for handling various segments of the end to end delivery of goods from manufacture to consumer. Information is not shared across all systems or locked in proprietary formats without convenient access or synchronization of all data copies. Older automated systems cannot react easily to changing conditions or requirements from business users.

### Current Practice for the Industry Include:

Placing a preferred set of carriers under contract with minimum performance guarantees including rates per lanes, committed number of trips per year, and flexibility by a carrier to refuse a request if overloaded or without spare capacity.

The X.12 standard committees have defined a set of EDI (electronic date interface) transaction formats in order to standardize industry communications; EDI standards and simpler XML replacement formats are available and used between major shipper and carrier organizations.

However, when a customer order cannot be fulfilled in the standard fashion, typically human agents will cycle through a set of potential other carriers, using trial and error or other non-systematic mechanisms to negotiate a spot-price agreement for the specific order and delivery deadline

The human agents will often contact and interact with other human agents, perhaps leaving messages and may wait one or more hours between contacts to notify additional potential carriers, since systematic means to consolidate carrier load information, recognize spare capacity, or determine correct spot-rate price levels are not available, nor wide-spread, for out-of-channel processing. Consequently, orders not processed routinely are often expensive to complete in terms of labor and price.

### Deficiencies of Conventional Practices

Some key challenges in conventional practices include, but not limited to:

Software logic is hard-coded or inflexible and difficult to change and validate;

End users cannot always see or easily understand key business relationships and trends for managing shippers' orders, carrier tenders, agreed pricing, or delivery status;

Business exceptions are designed to be handled manually which slows down the end to end process, obscures systematic evaluation and correction of behaviors, and lessens overall business efficiency;

Shippers may pay more than the minimum amount or best pricing available; Carriers may not be contacted in a timely fashion to bid on open loads; Business partners may not have the most efficient mechanism to connect, offer, respond, or otherwise agree on spot rate pricing;

Certain orders may be delivered late, or delivery missed entirely due to slow cycles of communication and lack of visibility and information sharing.

For example, the following symptoms are evident in conventional systems. First, they are time consuming as conventional systems can only go through 4 to 5 carries a day and operates between 8 to 5 o'clock. Traffic coordinators' manual efforts could take up to 4 days to find a carrier to tender the load to. A manual paper trail creation of spot bid for audit compliance increase inefficiency and human resource usage. Another symptom is an ad-hoc carrier identification. Traffic coordinators can contact any carriers, through any method. Lacking visibility into the current status of the effort to achieve load acceptance of these loads by the carrier. Another symptom is cost. For example, an average truck load cost can be calculated, but negotiations of the rate favor the carrier and can be up to 300% more than the contracted bid rate with a potential of additional surcharge for “dead-haul.” Another symptom is unpredictability. Carriers' acceptance of a tender does not mean that load will actually be picked up on time. Thus the DC do not have the goods they need to send to the stores. Due diligence is left completely up to traffic coordinator.

### Goals of This Invention

The Carrier Load Optimization (“CLO” or CaLM) solution herein includes the following goals:

Automate and manage open negotiations for spot price rates when required to ensure delivery of goods;

Manage tender offers for preferred shippers under contract;

Maintain up-to-date carrier rankings based on delivery performance and capacity views;

Employ machine learning to understand and trigger spot-rate price changes and thresholds;

Provide clear, and timely dashboard of summary data, drill-down capabilities, and other data visualization for end-users such as shippers, carriers, agents, and insurers;

Ensure secure control and management capabilities for authorized internal system administrators.

### SUMMARY OF THE INVENTION

Aspects of the present disclosure leverage available and easily accessible logistics data to create linkages between trucks and loads based on criteria of (1) availability, (2) performance over time/rating, (3) average cost per shipment (per carrier), etc. to reduce costs and increase efficiencies for the shipper. Data collected by Retailer is processed using a Carrier and Load Management (CaLM) tool's algorithms to determine effective pairings of trucks and loads.

The present disclosure issues an electronic invitation to a carrier to accept or reject a specified load/delivery. An “Accept” response from the recipient carrier creates the relationship automatically between carrier and load, and is recorded within CaLM for audit tracking and display via graphical user interface “dashboard” views. A “Reject” response causes the invitation to be resent to other carriers until a linkage is made.

CaLM creates efficiencies in the logistics/shipping environment that are currently unavailable. CaLM leverages data in conjunction with CaLM's algorithms and processes to reduce costs to the (shipper) user, increase efficiencies, and lower the number to zero (or close to it) of manual involvement in the carrier/load relationship environment. Numerous analytical metrics are displayed in the dashboard views.

Deep machine learning is based on a set of algorithms that attempt to model high-level abstractions in data by using a deep graph with multiple processing layers, composed of multiple linear and non-linear transformations. The systems herein can learn the structure of streaming data, make predictions and detect anomalies. They learn continuously from unlabeled data. Other attributes include that memory is primarily a sequences of patterns, that behavior is an essential part of all learning, and that learning must be continuous. The Biological Neural Network approach streams the data from each analyst (such as the details of the files routinely accessed, numbers of emails, numbers of postings, etc.) and automatically builds individual models of normal behavior for each person. The system then predicts what would be normal for each analyst and would flag anything abnormal. One can stream a lot of different metrics without knowing which will be important—all the modeling is automated.

### BRIEF DESCRIPTION OF THE DRAWINGS

FIG. 1 is a component diagram showing the set of modules for Carrier Load Optimization in the preferred solution.

FIG. 2 is a block diagram depicting the key transaction set used for the EDI (electronic data interchange) between the system and set of external carriers.

FIG. 3 is a process flow diagram illustrating the logic for handling a new delivery order through to confirmation or expiration.

FIG. 4 is a state transition diagram of the allowed event sequence for a Delivery order in the preferred solution.

FIG. 5 is the table form of allowed state transitions for a delivery order in the preferred solution.

FIG. 6 illustrates a dynamic Spot Rate based on an exemplary spot pricing curve

FIG. 7 illustrates the difference of two dynamic Spot Rate examples.

FIG. 8 depicts the computer systems, databases and networking for implementing one or more aspects and/or elements of the system and method for Carrier Load Optimization, according to one embodiment.

FIG. 9 illustrates a functional diagram of the Carrier Load Optimization system.

FIG. 10 illustrates a functional block diagram of some of the data and communication flows throughout the Carrier Load Optimization system.

### DETAILED DESCRIPTION

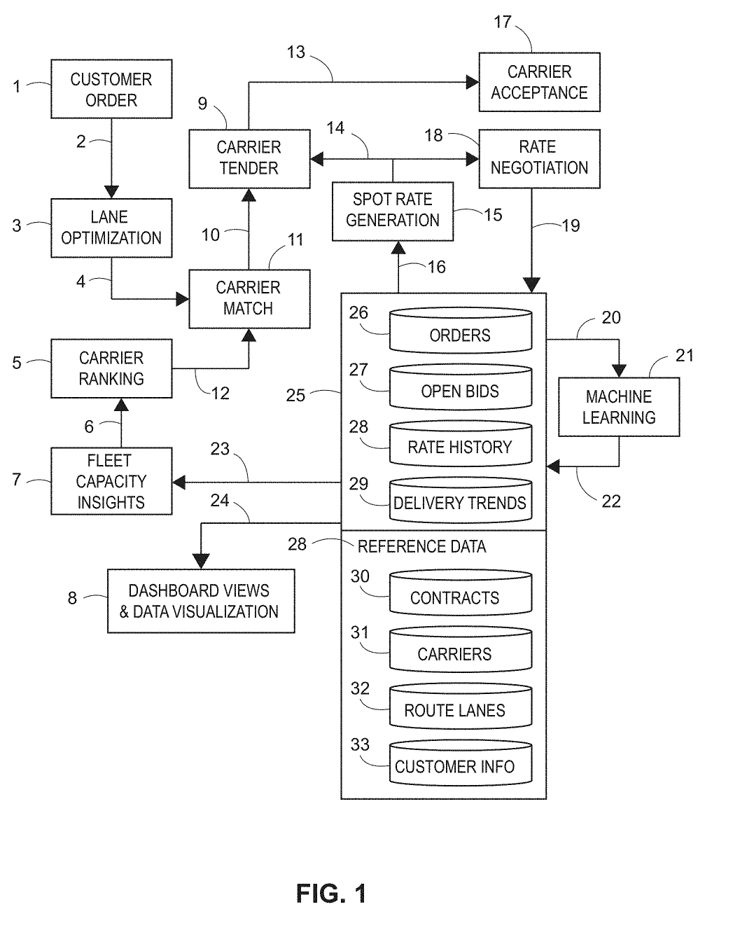

FIG. 1 is a component diagram showing the set of modules and key interactions of the Carrier Load Optimization process of the preferred solution.

As evident to practitioners of ordinary skill in the software industry, not all details are depicted in order to avoid cluttering the diagram with overlapping arrows or connections. For example, only: Customer Order module 01 will refer to and maintain the data files 25 such as Customer info data file 33, and add or update the current Orders data file 26 and lack of a connection drawn does not preclude nor prohibit such interaction, which is required as an obvious manifestation in any implementation of a solution.

### Customer Order Module:

The Customer order module 01 captures the delivery order request that specifies minimally, but not limited to, the pickup address, the destination address, the requested delivery due date, and optionally additional orders details such as delivery deadline, cancellation instructions, and special handling requirements.

### Lane Optimization Module:

The Lane Optimization module 03 receives minimally the pickup and delivery addresses 02 from the Customer order module 01 and maps to the predefined delivery route, or lane, from the Route Lanes data file 32.

### Carrier Match Module:

Carrier Match module 11 uses the Lane information 04 and Carrier rank information 12 to determine the eligible or best set of candidate carriers 10.

### Carrier Tender Module:

Carrier Tender module 09 uses the candidate carrier list 10 to make an initial offer, known as a tender 13, via EDI (electronic data interchange) to each carrier using the standard contract carrier rates, as referenced in the Contracts data files 30. In the event that none of the initial tenders are accepted, or no contract carriers are listed or available, then the carrier Tenders 13 are sent using the solution derived spot rates 14 for delivery.

### Spot Rate Generation Module:

Spot Rate Generation module 15 generates a dynamic, or custom, carrier delivery rate, known as a spot rate 14 whenever a standard contract rate cannot be used. The Spot Rate logic is based on live information 16 derived from data file information 25 such as Rate History 28 and Delivery Trends 29

### Rate Negotiation Module:

Rate Negotiation module 18 is employed in the event a carrier tender response indicates a different rate than was tendered 13. The Rate negotiation module uses subsequent or updated spot rates 14 to arrive at a final agreed carrier rate for the delivery of the specific Customer order 26.

### Carrier Acceptance Module:

Carrier Acceptance module 17 confirms the carrier responses to a tender 13 are acceptable, employing rate negotiation 18 if required. Accepted rates 19 are recorded as part of the overall Rate History 28 data file information.

### Machine Learning Module:

Machine Learning module 21 uses transaction event 20 information to consolidate and update 22 the delivery trend information 29 that forms the basis for Lane Optimization 03, Carrier Match 11, and Spot Rate Generation 15 of an implementation of a solution according to the present disclosure.

### Database Repository:

Database Repository 25 includes, but not limited to, online transaction oriented data files or tables such as Orders 26, Open Bids 27, Rate History 28, and Delivery Trends 29, plus a set of reference information 28 which may be maintained within the same system or as separate enterprise-wide database systems, including the Contracts 30, Carriers 31, Route Lanes 32, and Customer information 33 data-modeling subject areas.

### Dashboard Views Module:

Dashboard views, including Data Visualization 08 provide end-users and system administrators with summary information 24 regarding the state of the system, status of individual open bids 27, as wells as overall rate history 28, and delivery trends 29.

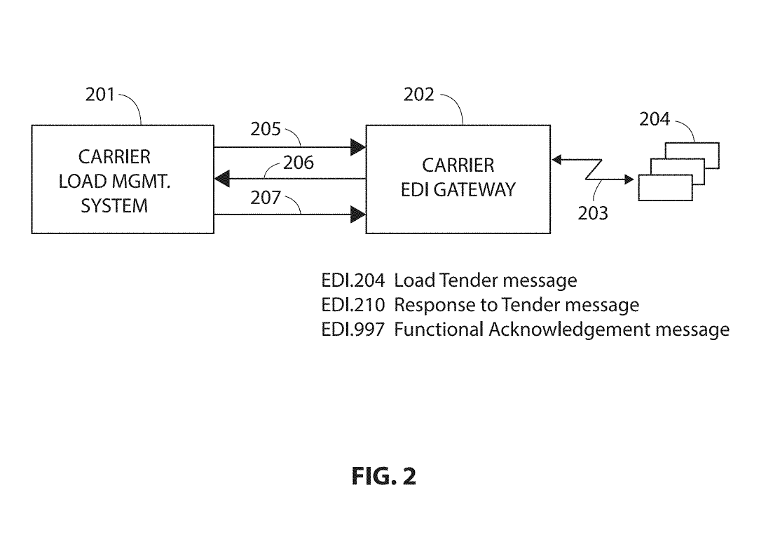

FIG. 2 is a block diagram depicting the key transaction set used for the EDI (electronic data interchange) between the system 201 and set of external carriers 204 via the Carrier EDI Gateway module 202. The EDI transaction set is defined in the X.12 set of standards for Carrier interaction and negotiation with various Shippers such as distribution centers using online electronic means. The Carrier EDI gateway 202 sends and receives various messages over public networks 203.

According to an aspect of the present disclosure, the Carrier Load Management system 201 sends an initial message 205 conforming to the EDI 205 transaction ‘Motor Carrier Load Tender’ X.12 specification to a specific carrier entity, the carrier replies with a response message 206 conforming to the EDI 210 ‘Response to Tender’ X.12 specification; the system 201 sends a confirmation message 207 conforming to the EDI 997 ‘Functional Acknowledgement’ X.12 specification.

In alternate embodiments, the EDI Gateway functionality is implemented using XML, HTTP or other standard protocols and specifications in lieu of X.12 EDI formatted message 203, while retaining the Gateway API elements, namely 205, 206, 207 without change.

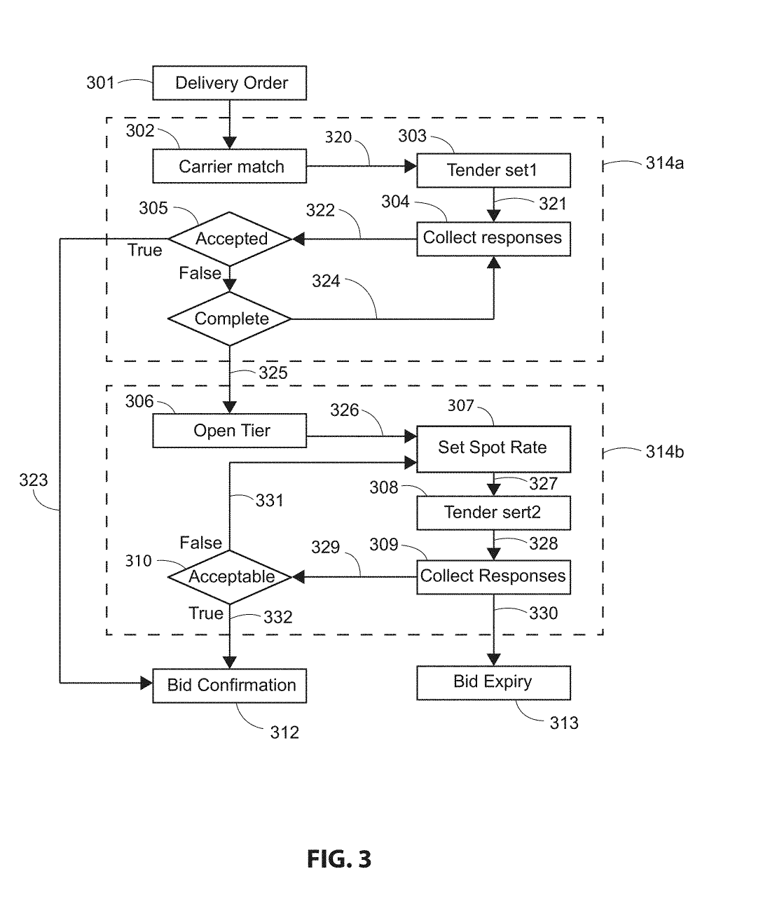

FIG. 3 is a process flow diagram illustrating the logic for handling a new delivery order through to confirmation or expiration. The customer order 01 of FIG. 1 manifests as Delivery Order 301 in FIG. 2 based on the order 301.

In a first processing stage 314a, a carrier match 302 is used to determine a set of preferred carriers 320 under contract for standard rates that comprise tender-set-1 303. The individual carrier responses 321 are received into Collect Response 304; each such response 322 is inspected and if accepted 305 is passed 323 for Bid confirmation 312, thereby ending the processing of the bids 303 for that order 301. In the event a bid is not accepted, and not all bids responses have been received, the processing returns 324 to Collect Responses 304; however in the event the all bids 303 have been received 321 and none are accepted or the allowed time for the first processing stage has elapsed, then the processing is passed 325 to a second processing stage 314b.

In a second processing stage 314b, the bidding is opened 306 to a wider set of carriers including those not under contract for the initial preferred rates. For each carrier 326 in the open tier 306, the system sets a dynamically calculated spot rate 307 and the tender 327 submitted as part of the tender-set-2 308. The individual carrier responses 327 are received into Collect Response 328; each such response 329 is inspected and if acceptable 310 is passed for Bid confirmation 332 hereby ending the processing of the open tier 306 bidding. In the event a bid is not acceptable, the processing returns 331 to Set Spot Rate 307 for a new round of tenders; however, in the event the deadline for the order 301 has elapsed, the second processing step 314b is exited 330 and the bid expired 313.

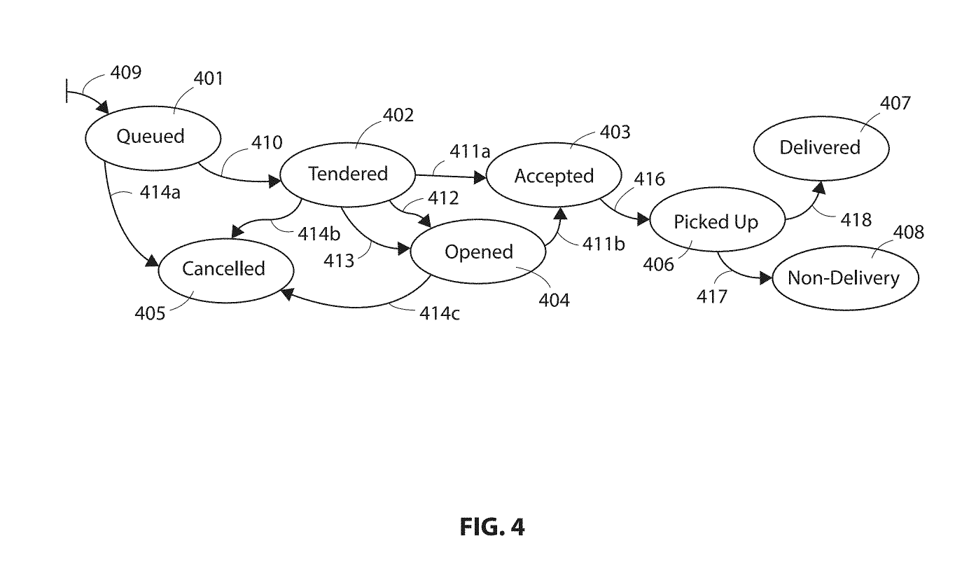

FIG. 4 is a state transition diagram of the allowed event sequence for a Delivery order.

The beginning event 409 initializes an order in the Queued state 401. Once queued, tender offers are distributed 410 and the order marked as Tendered 402. A tendered order 402 may be accepted 403 for delivery by a carrier 411a, or rejected by all carriers 412 or timeout 413 opening the order to additional carriers. Once Opened 404, new tenders are submitted with dynamically calculated spot rate price offers. Event 411b marks the acceptance of a given tender and associated spot rate by one of the carrier moving the order to the Accepted state 403. However, at any time before acceptance, an order may be withdrawn (reference: events 414a, 414b, 414c) and moved to the Cancelled state 405.

Event 416 indicates a carrier has assumed responsibility for the order, moving said order to the Picked IP state 406. Once picked, the order is either completed 418 and marked Delivered 407, or fails 417 and marked as Non-delivered 408.

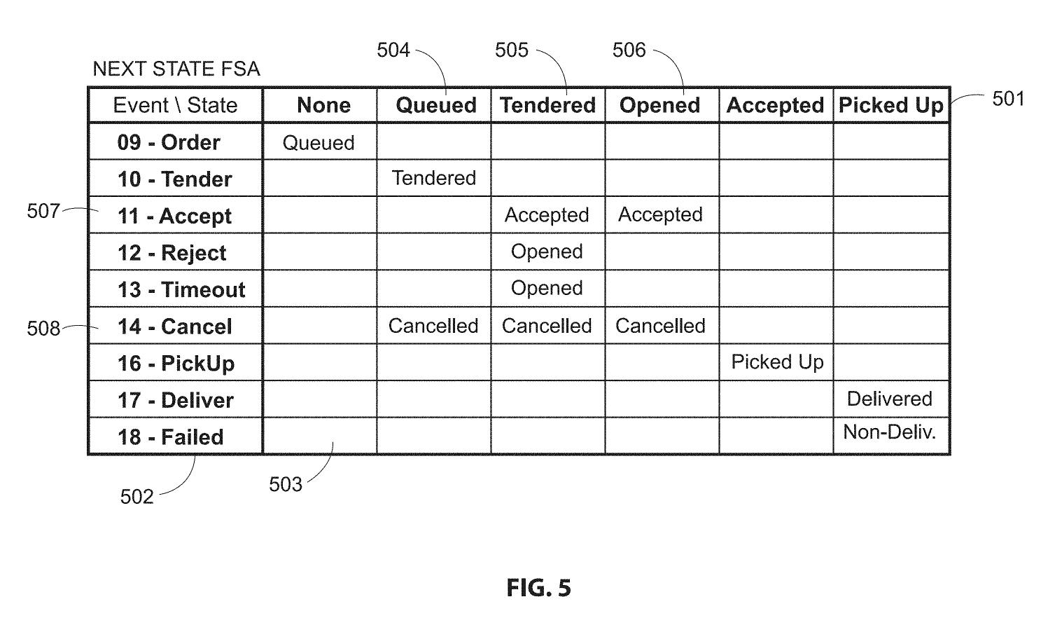

FIG. 5 is the table form of allowed state transitions for a delivery order in the preferred solution. To the practitioner of ordinary skill in software development, the state transition table values indicate the allowed state changes from a given state to the next state according to the stated finite set of events.

The table in FIG. 5 shows events 502 in the left side column, and current states 501 as the column headers in the topmost row. The allowed next states 503 are given in the body of the table.

For example, as shown: both Tendered 505 and Opened 506 states will move to the Accepted state next on the occurrence of the 11-Accept event 507, but the said 11-Accept event is not allowed unless the order is in either the Tendered 505 or Opened 506 states.

As a second example, as shown: an order can be withdrawn on the occurrence of the 14-Cancel event 508 from the any of the Queued 504, Tendered 505, or Opened 506 states, but the 14-cancel event 508 is not allowed before the order is created in the Queued 504 state nor once the order is in a Picked Up, Delivered, or Non-Delivered state.

Likewise, the rest of the allowed state transitions are evident in the said table of FIG. 5 in the following fashion: the Finite State table shows the entire set of allowed state transitions in a compact powerful form using the following exemplary logic:

IF (NextState:=Table[State, Event])=null),

then Event not allowed, else State:=NextState”.

The associated software solutions disclosed herein can be implemented optionally in various languages and techniques to the same or equivalent effect as would be understood by those of ordinary skill in software development.

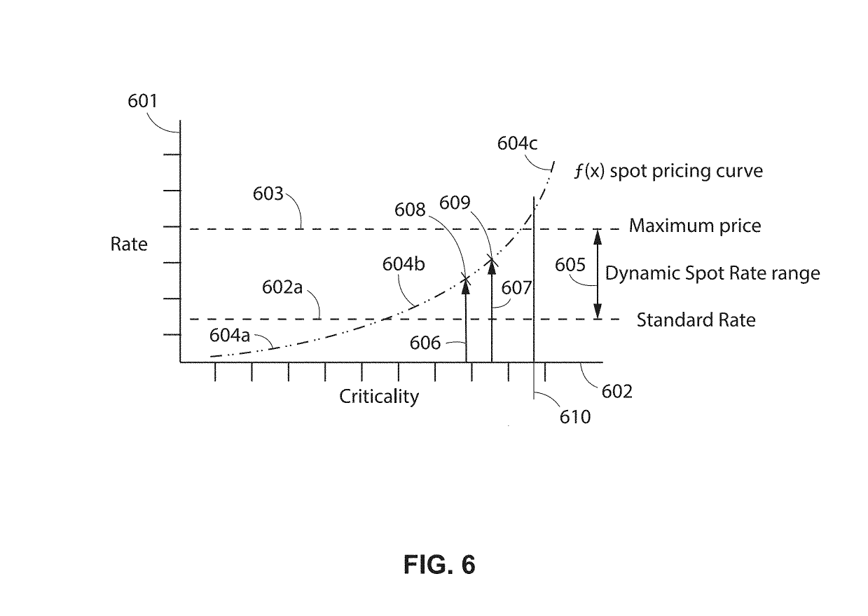

FIG. 6 illustrates the determination of a dynamic Spot Rate based on the calculated spot pricing curves 604a,b,c. The graph is shown with vertical axis 601 showing the rate that is effectively the price paid for delivery of a given load on a given route or lane. The horizontal axis 602 shows the time criticality of the order with increasingly critical dates to the right hand side as the deadline date 610 for delivery is approached. The standard rate 602a is a minimum rate defined by the contracted carriers for a given route or lane. The maximum rate 603 is an optionally parameter defined in the customer order or calculated by the solution based on prior pricing history and current delivery performance and pricing trend. The operative spot pricing segment 604b of the pricing curve determines how the price increases as a function of time criticality for pickup and delivery for the lane; the range of prices or rates in said segment 604b defines the extent 605 of the dynamic spot rate range. For example, two spot prices are shown: the first price 608 is identified by the remaining time 602 for pickup and delivery; the second price 609 reflect the higher rates associated with a more critical date 607 that is closer to the order deadline 610. The higher rate is negotiated or accepted in order to secure the carrier commitment to deliver the order by the requested order delivery date.

The actual shape of pricing curve 604 shown in the FIG. 6 example as a concave function can be determined based on the available carriers, delivery performance trends, and historical rates relative to the time criticality of the given order for each specific lane.

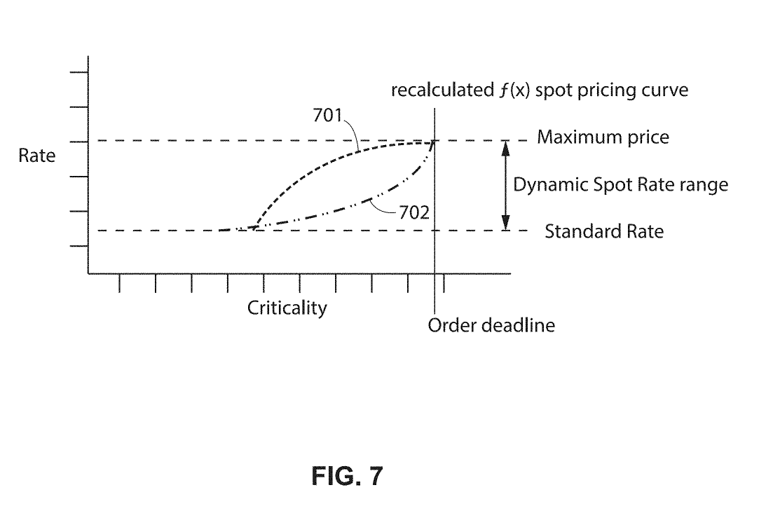

FIG. 7 illustrates an example of a determination of a dynamic Spot Rate 701 based on recalculation of the spot pricing curve relative to the FIG. 6 exemplary curve 702. The recalculated curve 702 shows for example only that this lane at the deadline for this indicative order would be higher and rise more quickly 701 in a convex fashion relative to the concave example 702.

### Implementation Detail

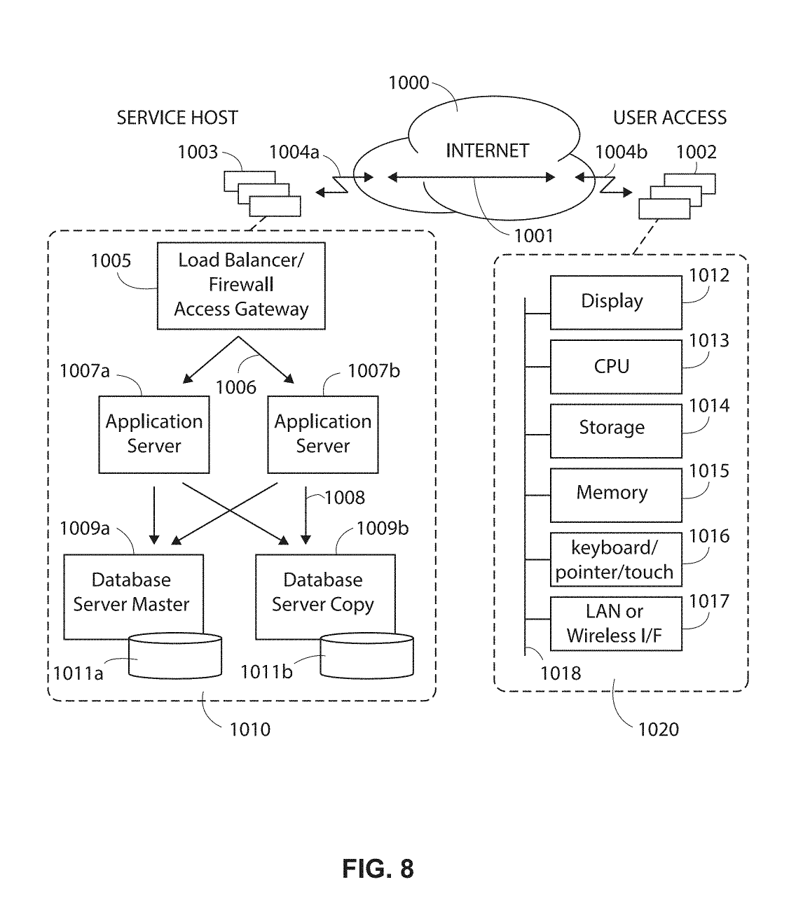

FIG. 8 depicts example computer systems, databases and networking for implementing one or more aspects and/or elements of the system and method for Carrier Load Optimization, according to an embodiment.

The Internet 1000 composed of many individual but connected networks operates on a standard protocol stack characterized by using the standard protocols of TCP over IP to transmit requests and replies including but not limited to higher level protocols using the data payload of TCP delivered messages. The logical connection 1001 can be viewed as conduit for connecting two or more computing endpoints 1004 across one or more routers, switches, wired and/or wireless circuits as a means of logical attachment between said end points.

Service Host devices 1003 are reachable 1004a as designated address points in the Internet 1000 using standard routing protocols in the OSI Reference Model. Clients 1002 provide user access 1004b to information and features and/or functionality provided by the Server host machines via the network 1001. Server hosts 1003 in an example embodiment are composed of multiple resources arranged to provide redundant, fault-tolerant computing; each such resource within the Host configurations 1010 is understood easily by those skilled in the art as more powerful, more robust, and in many cases more specialized elements of the standard computer 1020.

The server Host configuration 1010 involves a front end device 1005 to load balance 1006 the request messages across one or more equivalent Applications servers 1007a, 1007b. The front end 1005 can also include the network connection, security firewall as integrated or separate discrete network elements. The Application server 1007 provides the software container to execute the software logic in order, including the operating systems, application programs, reusable application modules according to defined computer configuration and loaded sequence of computer operation instructions in order to perform the defined service function. Application Servers 1007 access, retrieve, and maintain system database information and contents in a logical fashion only; physical storage elements, can be distributed, as depicted in FIG. 8 host configuration 1010 as discrete database servers 1009a, 1009b, connected in a redundant fashion 1008 between one or more Database servers 1009 containing storage elements 1011a, 1011b. A given storage element may contain all or part of a Server host 1003 data set, but logically one copy of data is accessible as the master or current copy of data values 1009a, and one or more copies may be maintained as active (read-only), stand-by or offline backup copies 1009b. Those skilled in the art understand that the data copies may include application program, configuration and alternate configuration information, which allow system interruptions to be corrected by rerouting the message streams between elements to restore or continue service operation within the server Host 1003 according the server host configurations 1010.

User endpoints 1002 may be any of the readily available commercial products known as desktop, laptop, tablet, or smart phones which server as general purpose computing devices with access to online services 1004 provided by various server hosts 1003 over the Internet 1000.

A user endpoint 1002, as is readily understood by those skilled in the art, is further described in the block view 1020, as follows. Each such user device 1002 is implemented as of a typical computer or computing device 1020 for use as a client 1004b according to one embodiment. Illustrated are at least one processor 1013 coupled to a bus 1018. Also coupled to the bus 1018 are a memory 1015, a storage device 1014, a keyboard and/or pointer and/or touch sensitive surface 1017, and graphics display device 1012 coupled via a standard graphics adapter

The processor 1013 for laptops and desktops can be any electronic computing processor such as an INTEL or AMD x86 compatible-CPU, including multi-core chip sets; the Processor 1013 for mobile phones can be any of the NVIDIA Tegra 3, or Qualcomm Snapdragon S4 SOC (system on a chip). The storage device 1014 can be, for example, a hard disk drive or a solid-state memory device but can also be any other device capable of storing data, such as a writeable compact disk (CD) or DVD. The memory 1015 can be, for example, firmware, read-only memory (ROM), non-volatile random access memory (NVRAM), and/or RAM or level-II cache, and holds instructions and data used by the processor 1013. The user inputs to the computer system 1020 are received via the input interfaces 1016, which can be a physical or virtual keyboard via a touch sensitive screen or surface, in combination with mouse, track ball, or other type of pointing device. The Display 1012 presents text, images and other information on an electronic device screen. The network adapter 1017 couples the computer 1020 to the network 1000 over wired or wireless protocol connections 1004b.

As is known in the art, the computing device 1002 and more specifically the operating system executing in CPU 1013 from memory 1015 is adapted to execute computer program modules. As used herein, the term “module” refers to computer program logic and/or data for providing the specified functionality. A module can be implemented in hardware, firmware, and/or software. In an embodiment, the modules are stored on the storage device 1014, loaded into the memory 1015, and executed by the processor 1013.

Application server 1007a of the Server Host Configuration 1010 is also readily understood by those skilled in the art as a variation albeit more powerful, more specialized, and less portable, of said computing device 1002.

In some cases, it is contemplated that embodiments of this disclosure can be implemented using a single instance of User computing device 1002 connected via the internet to a single Server host 1003, while in other embodiments multiple such systems, or multiple nodes making up the end to end computer system 1030, can be configured to host different portions or instances of embodiments to deliver the specified software features and functions of the present disclosure.

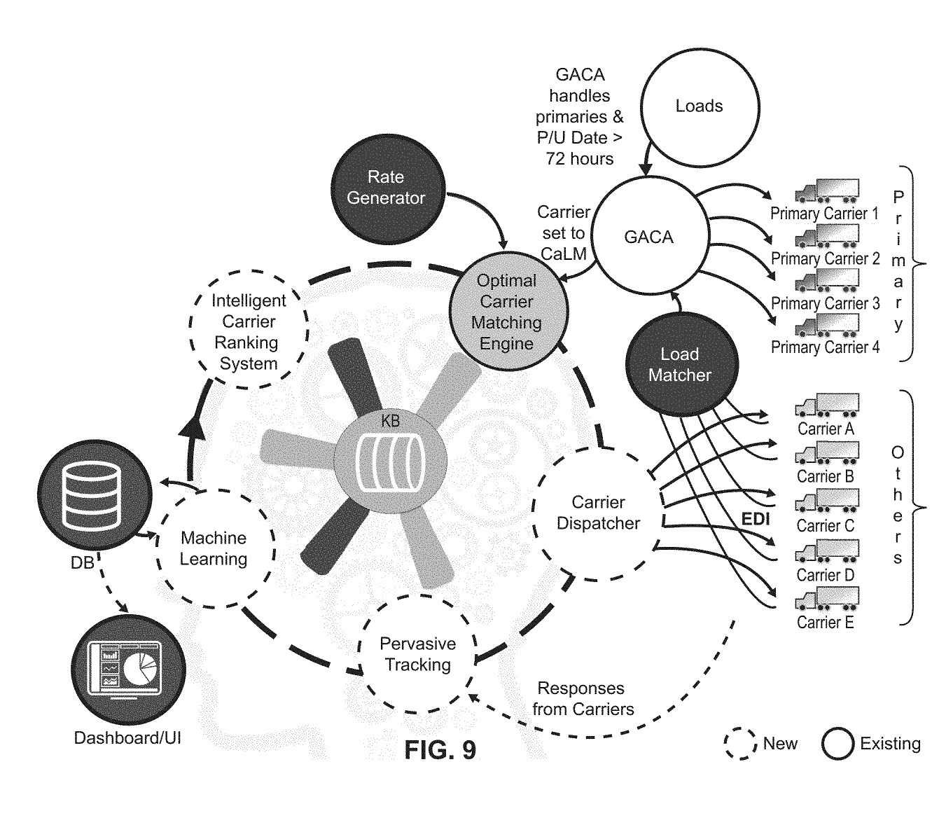

FIG. 9 illustrates a functional diagram of the CaLM system. The Intelligent Carrier Ranking module can be implemented using a Page Ranking algorithm, and it calculates Ranking based on various parameters (Pricing, Acceptance, Lane history etc).

The flow starts with Loads, then GACA, followed by the optimal carrier matching algorithm. The GACA module handle primaries, and the denial from all primaries is a trigger.

The Carrier Matching engine can be implemented using Gale & Shapley's Match Making algorithm. It takes inputs from Ranking system and finds the optimal carrier(s) by matching the ranked carriers with the load requirements (e.g., Urgency, type of load, preferred Rates from Rate Generator). It thus calculates the most probable carriers that would take the load.

The load information along with the calculated rates are dispatched to selected carriers via the Carrier Dispatcher that handles the EDI integration.

The carriers respond back, e.g., within 2 hours, and the Load Matcher identifies the best carrier based on winning criteria such as first response, preference, etc.

The Load information, selected carriers, and the Carrier response all are captured by the Pervasive tracking and fed to the deep learning step.

The Deep learning captures all of carrier responses and via artificial intelligence will provide the inputs for the Dashboard view. It also will help in effectively predicting the carrier responses for load requirements.

The inputs from the Deep learning module keep the Dashboard views current in real-time for both a traffic coordinator and executives of an enterprise.

The carrier ranks are updated by the Deep learning module. This sets the preferences for the carrier load that needs to be processed in future on that lane.

Strict software state control 501, 502 and management 503 allow the solution for Carrier Load optimization to ensure timely and cost-effective load tendering 09 and delivery across a set of preferred and shippers 314a as augmented by a supplemental set of authorized secondary shippers 314b based on dynamic spot price determination 307 for a given lane 32, carrier 31, and order deadlines 610 or criticality. Machine learning 21 continuously maintains and updates 22 the current understanding of prior rate history 28, previous and current spot price negotiations 19, availability, and performance 29 of candidate carriers on a lane by lane and order 01 by order 01 basis.

The present disclosure gathers and processes technical and logistics data from existing corporate systems and databases and analyzes and acts on that data via CaLM algorithms to increase efficiencies. The algorithm assigns trucks to loads in a manner not currently possible with existing systems, processes, and configurations. A dashboard view of scheduling, trucks, loads, vehicle schedule tracking, and carrier performance/cost over time improves usability, speed, and efficiency.

Once installed and linked with existing databases, CaLM monitors for trucks designated with “Traffic” status. Trucks and carriers are identified according to availability, score card, cost per load (determined over time), and other criteria selected by the user.

An aspect of the present disclosure generates WL-compatible data to send notices to applicable carrier(s) that a load is ready, and to query the recipient (carrier) as to scheduling and availability.

Recipient carrier can accept the load assignment, whereupon the system database is updated in real-time with this new linkage of carrier and load. If recipient rejects/cancels the assigned linkage, CaLM resends the request to other applicable carrier(s) until an acceptance occurs.

When a carrier accepts the proposed load, the algorithm updates the “Accept” status into the Carrier/Load/Acceptance database for display in the dashboard.

An “Accept” status by a carrier is considered a “dispatch” of that carrier for the load specified, thus automating the current system, which sometimes requires manual linkage of carrier to load, and dispatching. An acceptance or rejection in CaLM occurs in real-time with data flow and updates to the information displayed in dashboards instantaneously.

Updated status of truck and load is sent to existing systems for multiple methods of access by administrators, planners, and managers.

Aspects of the present disclosure include seamless integration with existing systems, and machine learning capabilities that allow for more efficient linkages and acceptances, and cost-savings over time by identifying efficiencies and deficiencies including the critical metric of cost-per-load per carrier.

The CaLM dashboard view provides real time analytics, truck/load linkages, statuses, scheduling, truck and load tracking details and more in a user-friendly graphical user interface.

Advantages of the present disclosure include at least the following in addition to those listed herein.

### Increases Operational Efficiencies

Instant communication to carriers provides rapid reaction capabilities for the carrier and the shipper. CaLM significantly reduces manual efforts in matching trucks to loads, and the associated stressors on personnel and costs for shipping.

### Supports Audit Trail and Transparency

Full transparency into the carrier/load process provides a deeper understanding into the price-per-lane shipping cost on a per carrier basis. Insight into price-per-lane allows a greater command of the contract bidding cycle for managers and executives of an enterprise.

### Provides Management Analytics and Actionable Insights

CaLM provides actionable analytics via a user-friendly dashboard with multiple layers of details including ranking and trend data to provide managers and executives with critical real-time decision-relevant information. Trend data automatically identifies carriers with high scores based upon specific measures and criteria. Insight into carrier availability, costs, and performance over time provides rankings upon which operational decisions can be made to reward quality, increase savings by leveraging data for contract negotiations, etc.

### Reduces Operational Costs

Increases efficiency of matching trucks to loads, then tracking same significantly reduces losses for large businesses by lowering the number of missed and late deliveries. Losses associated with unnecessary storage and stocking costs/charges are also avoided. The shipper can save significant operational costs by knowing which carrier has the lowest cost per load.

### Leverages Existing Data Sources

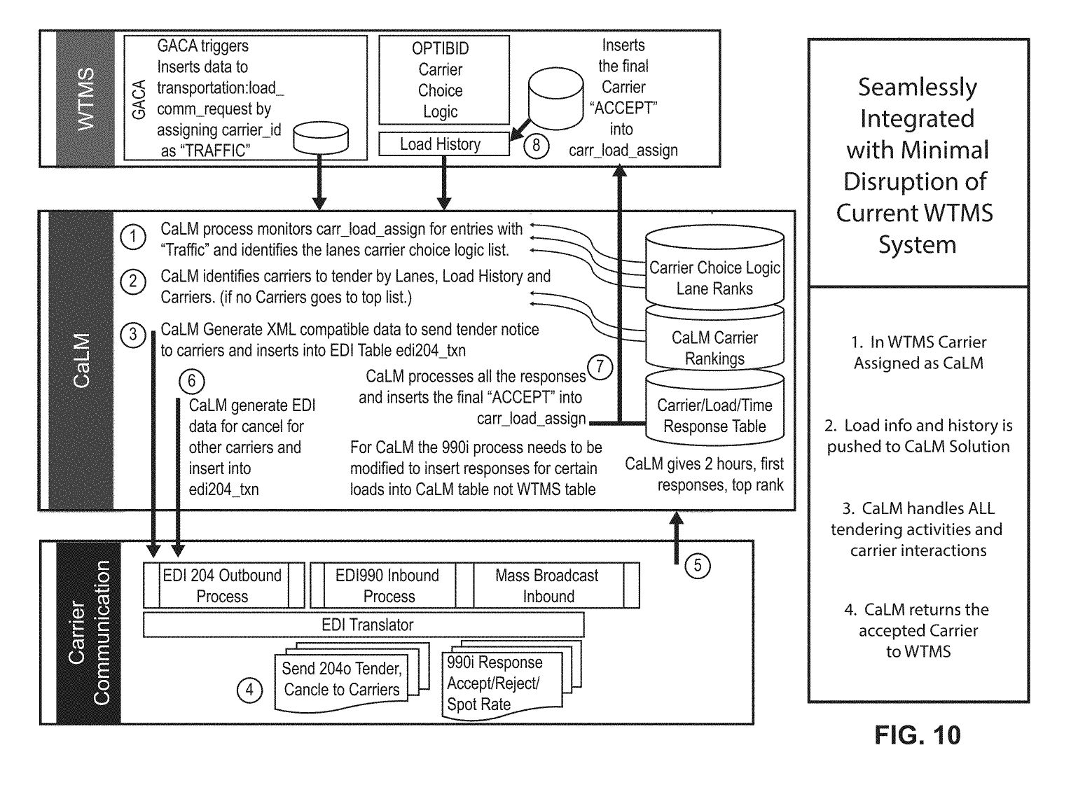

CaLM aggregates, analyzes, processes, and leverages data that is already captured by an enterprise's existing networks. Implementation of the present disclosure is therefore seamless, non-intrusive, and non-invasive to legacy systems, such as shown in FIG. 10.

What is claimed is:

1. A computer-implemented method of optimizing tangible carrier loads as they are transported across a transportation network by a transport carrier from a physical source to a physical destination, the method comprising the steps of:
receiving, over a computer network, a plurality of requests for delivery orders from a plurality of requestors of a tangible load, each of the requests for a delivery order including a pickup address, a destination address, and a requested delivery due date;
computing, for each of the plurality of requests for delivery orders, an optimum lane, based on the corresponding pickup address and the corresponding destination address, which corresponds to a predefined delivery route for transporting the corresponding tangible load from the corresponding pickup address to the corresponding destination address;
automatically determining, for each of the plurality of requests for delivery orders, a set of candidate transport carriers to fulfill the corresponding request for delivery order;
sending to each of the set of candidate transport carriers, for each of the plurality of requests for deliver orders, via an electronic data interchange, an initial tender that includes predetermined criteria for acceptance;
responsive to none of the candidate transport carriers of the set of candidate transport carriers accepting the initial tender, dynamically adjusting at least one of the predetermined criteria according to a function that increase a probability of acceptance and sending to at least some of the set of candidate transport carriers a revised tender that includes the dynamically adjusted criterion;
responsive to one of the candidate transport carriers of the set of candidate transport carriers accepting the revised tender, using at least the dynamically adjusted criterion, the optimum lane, the candidate transport carrier that accepted the revised tender, and historical delivery trends in a machine learning module to adjust the function;
causing to be displayed on an electronic video display indications of the requests for delivery orders that have been tendered, the requests for deliver orders that have not been accepted, and the requests for delivery orders that have not been picked up by a transport carrier.
